(19) United States
(12) Patent Application Publication
(10) Pub. No.: US 2016/0349952 A1
(43) Pub. Date: Dec. 1, 2016

(54) SHARING VISUAL REPRESENTATIONS OF PREFERENCES WHILE INTERACTING WITH AN ELECTRONIC SYSTEM

(71) Applicants: Michael Dean Tschirhart, Ann Arbor, MI (US); Anthony Joseph Ciatti, Ann Arbor, MI (US); Alexander Albanese, Oak Park, MI (US)

(72) Inventors: Michael Dean Tschirhart, Ann Arbor, MI (US); Anthony Joseph Ciatti, Ann Arbor, MI (US); Alexander Albanese, Oak Park, MI (US)

(21) Appl. No.: 14/725,716

(22) Filed: May 29, 2015

(51) Int. Cl. G06F 3/0484; H04L 29/08

(52) U.S. Cl. CPC G06F 3/0484; H04L 67/025

(57) ABSTRACT

Systems, methods, and devices are provided herein for sharing personal preferences with an interaction with an electronic system. The personal devices may be in a proximal distance from the electronic system, and connected via a network connection. The personal preferences may be set with an application or program, according to systems disclosed herein. The personal preferences refer to settings associated with an operator of each of the personal devices based on a desired interaction.

### BACKGROUND

Electronic systems may be employed to control a variety of tasks associated with entertainment, climate control, ergonomics, and the like. For example, the electronic system may be provided in a vehicle. The electronic system, through an interface, may interact with a user or multiple users, and be configured to provide an experience tailored to the user's preference.

A user may set the climate controls to a setting that the user prefers. The user may adjust the seat position in a manner the user prefers. Further, the user may interact with a control to choose the radio station or entertainment associated with a vehicle's entertainment system.

The examples provided above are directed to interactions with a vehicle. The electronic systems described herein may be implemented in a variety of locations, such as a home, a store, a computer system situated as a specific location, or the like. Thus, the electronic systems may be configured to provide an interface that allows individual users to manipulate inputs to provide a personalized experience.

Conventionally, the interactions have been provided with mechanical knobs and actuation devices. Recently, these interactions have been augmented or replaced with more modern input techniques, such as touch screens, voice-activation, gesture-control, or the like.

More and more, the electronic systems are being equipped with short-range wireless communication devices. Accordingly, a person interacting with the electronic system may handshake a personal device with the electronic system. A personal device may be any sort of device that allows the digital storing of information on the personal device, for example, a smart phone, a table, a smart watch, a personal computer, a smart card, or the like. The personal device may be equipped with a wireless transmission device (TX) that allows interaction with a reception device (RX). The personal device may also have RX capabilities, and receive transmissions via the electronic system via a TX device situated in the electronic system.

### SUMMARY

The following description relates to system and methods for sharing preferences while interacting with an electronic system. Exemplary embodiments may also be directed to any of the system, the method, an application provided on a personal device associated with the aspects disclosed herein.

Additional features of the invention will be set forth in the description which follows, and in part will be apparent from the description, or may be learned by practice of the invention.

A system for displaying personal preferences based on an interaction between a first and second personal device and an electronic system is described herein. The system is configured to interface with at least the first personal device and the second personal device in response to the first personal device and the second personal device being within a proximal distance from each other and the electronic system; a personal preference receiver configured to receive a first personal preference file from the first personal device, and a second personal preference file from the second personal device; a personal preference extractor to extract personal preferences from each of the received personal preference files; and a personal preference sharer configured to communicate the extracted personal preferences to a display associated with the electronic system.

A system for setting personal preferences for displaying via an electronic system in communicated with a personal device is described herein. The system includes an initiator to initiate an updating of the personal preference; a level setter to associate with the personal preference a permission of other personal devices that may view the personal preference; an application selector to select which of available applications to modify the personal preferences. The personal preference is configured to be displayed via a centrally provided electronic system, the electronic system configured to provide a localized network in which the personal device and other personal devices connect to.

A method for displaying personal preferences based on an interaction of a first and second personal devices and an electronic system is described herein. The method includes detecting whether either the first device and the second device are in a proximal distance from the electronic system; requesting personal preferences from the detected first device and the detected second device; receiving personal preferences from the detected first device and the detected second device; extracting personal preferences from each of the detected first device and the detected second device; categorizing the received personal preferences as being associated with either the detected first device and the detected second device; and displaying the received and categorized personal preferences.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example implementation of a system for sharing preferences for interaction with an electronic system.

FIG. 3 illustrates an example of a system for providing a preference to be communicated to a system shown in FIG. 2.

FIG. 4 illustrates an example implementation of a method for sharing preferences for interaction with an electronic system.

FIGS. 5(a)-(c) illustrate an example of an implementation of the systems shown in FIGS. 2 and 3 for providing control of a climate control system.

FIGS. 6(a) and (b) illustrate an example of an implementation of the systems shown in FIGS. 2 and 3 for controlling a radio station

FIGS. 7(a) and (b) illustrate an example of an implementation of the systems shown in FIGS. 2 and 3 for controlling a navigation system.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Electronic systems are provided to control a plurality of services, such as climate control, entertainment options, ergonomics and the like. The electronic system may be situated in a vehicle, home, store, office, or any environment associated with auxiliary services controlled and moderated by the electronic system.

As explained in the Background section, the electronic system may be situated with an interface. The interface allows a person interacting with the environment associated with the electronic system to enter or provide a preference based on the person's desire to interact with the electronic system. For example, the person may enter a specific temperature to deliver with the climate control system, a specific radio station to listen to, or a seat position.

In another example, the preferences of the other users may be displayed on a user's personal. Thus, the owner of one device may see or view the preferences of other users.

In another example, the person may have the preferences stored on a personal device. The personal device may be capable of wirelessly transmitting information to the electronic system. Thus, in response to the personal device being within a proximal distance with the electronic system, a handshaking between the electronic system and the personal device may occur, thereby leading to information being exchanged.

The conventional interaction techniques involve one person interacting with the electronic system. However, many situations involve multiple people being in an environment or context. Each individual person may have a specific personal preference associated with how they prefer the environment to be.

For example, person A and person B may both enter the vehicle. Person A may prefer the vehicle to be at a warmer temperature, while person B may prefer the vehicle to be at a colder temperature. Person A may control the electronic system, but be completely unaware of person B's preferences.

Disclosed herein are systems, methods, and devices for sharing preferences between individuals interacting with an electronic system. Because the aspects disclosed herein allow an automatic, non-verbal interaction, interactions may be facilitated in a more seamless manner. The aspects disclosed herein are further directed to visualizing the sharing, and thus, in addition to being cognizant of the multiple preferences, the electronic system may be coupled with a digital display, and be configured to display the multiple preferences.

The electronic systems associated with the aspects disclosed herein may be a centerstack display of vehicle with the ability to control climate, seating preferences, entertainment options, navigation, consumer recommendations, and the like. While many of the examples disclosed herein focus on a vehicle implementation, one of ordinary skill in the art will appreciate that the aspects disclosed herein may be implemented in a variety of environments and contexts.

Accordingly, employing the aspects disclosed herein, multiple users may share preferences without verbally communicating said preferences. Further, because in example, the preferences are shared in a digital setting, the operator of the electronic system may choose a setting that satisfies multiple people associated with the environment/context of the electronic system. Other interfaces, such as analog settings may also incorporate the aspects disclosed herein.

A personal preference, in one example, may be a specific instance, number, or item that an individual user prefers. In another example, the personal preference may be a range associated with a setting (for example, a range associated with a desired temperature setting). In another example, the personal preference may be a distribution or descriptor of the present, e.g., a genre of music or type of food. Thus, whenever the term personal preference is employed in this application, any of the above enumerated definitions may be employed (either alone or in combination). Another example of a distribution may be that the user may prefer to listen to one genre of music 75% of the time, and a second genre of music 25% of the time.

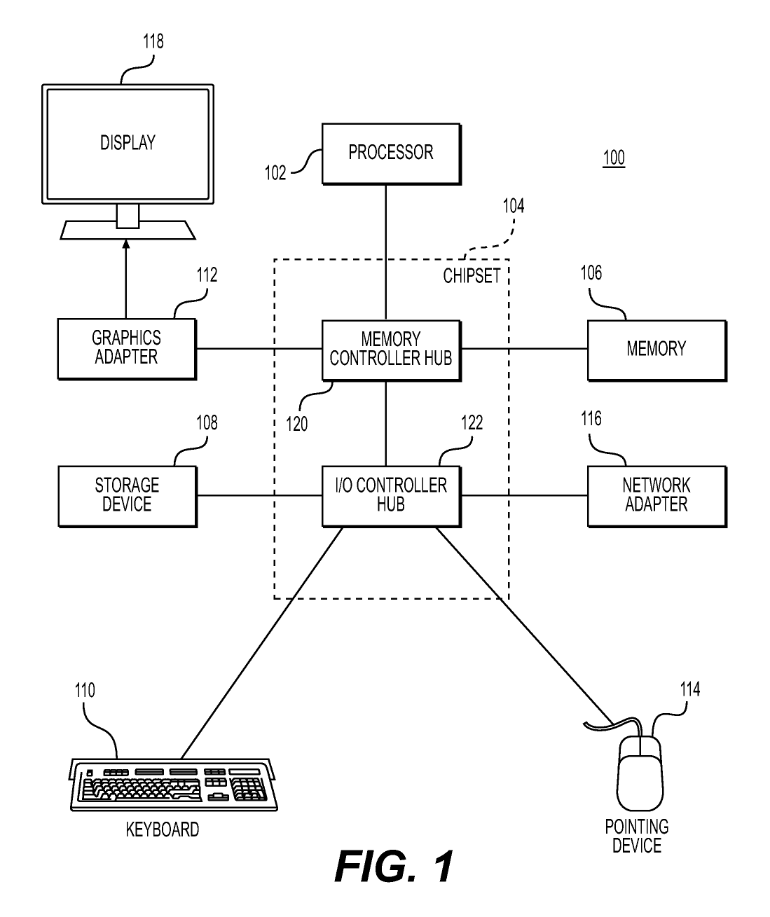

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network.

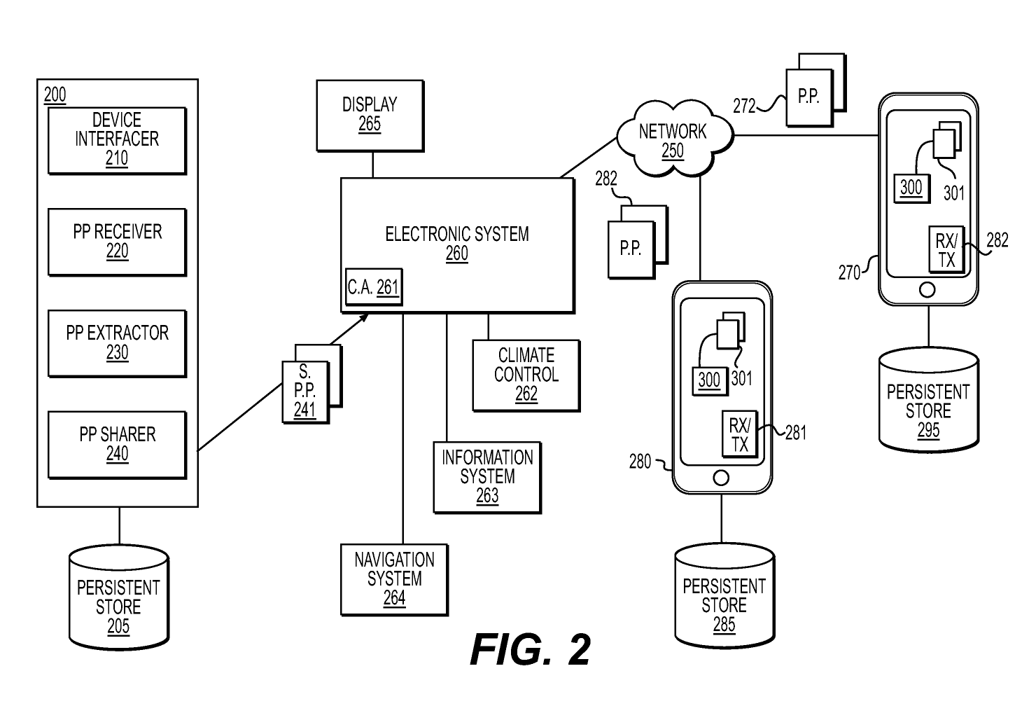

FIG. 2 illustrates an example implementation of a system 200 for sharing preferences for interaction with an electronic system 260. The system 200 may be implemented on a computer, such as the computer 100 described above. The system 200 includes a device initiator 210, a personal preference receiver 220, a personal preference extractor 230, and a personal preference sharer 240.

As shown, the system 200 communicates with an electronic system 260. The system 200 may communicate with the electronic system 260 via a network 250 or through a bus system that wired or wirelessly communicates with the electronic system 260. In certain implementations, the system 200 may be integrated and incorporated with a storage device 108 included in the electronic system 260.

The electronic system 260 includes a communication adapter 261. The communication adapter 261 may be any communication device capable of employing wireless or wired communication techniques to communicate with other devices. The electronic system 260 may also include various control circuitry to communicate with auxiliary services. The auxiliary services may relate to systems associated with interacting with an environment, such as, a climate control system, an entertainment system, an ergonomic system, a navigation system, or the like.

As shown in FIG. 2, the devices 270 and 280 (which are shown as smart phones, but may be any sort of personal digital device) each contain RX/TX devices, 271 and 281, respectively that communicate and handshake with the electronic system 260. The number of devices that interact with the electronic system 260 may vary. Thus, the depiction of two devices is merely exemplary.

Devices 270 and 280 may each include a persistent store (persistent store 275 and persistent store 285). The persistent stores 275 and 285 may be storage devices, such as those enumerated above with regards to storage device 108.

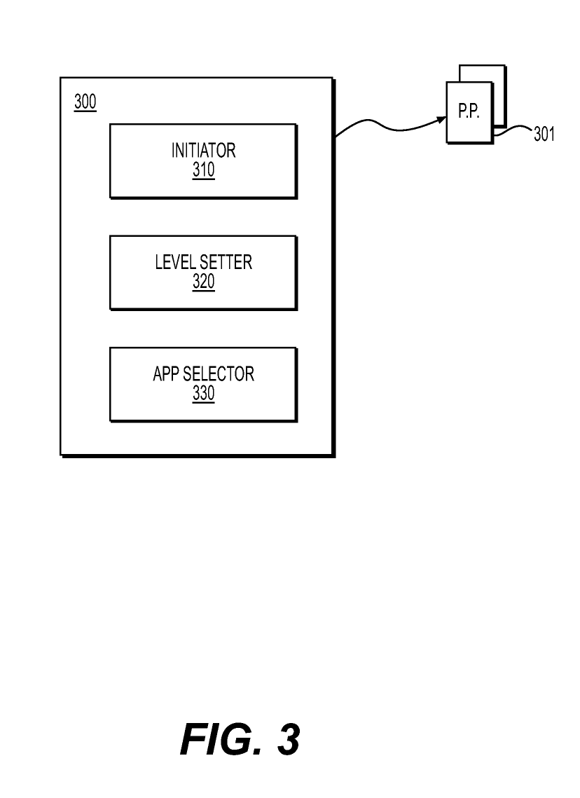

The persistent stores 275 and 285 each include system 300, which is shown in FIG. 3. FIG. 3 illustrates an example of system 300 for providing a preference 301 to be communicated to a system 200. The explanation of system 300 will be described in further detail below.

The persistent stores 275 and 285 interact with the system 300 (which is integrated into the personal devices 270 and 280) and stores personal preference information associated with the owner/operator of each device. The personal preferences, such as personal preference 272 or 282 may be related to personal preferences associated with one or more services associated with electronic system 260, or for multiple electronic systems (not shown).

The personal preferences (272 and 282), which may be any sort of file capable of storing digital data, are communicated to the system 200 via the network 250.

The device interfacer 210 interfaces with the various devices in proximity of the electronic system 260 via network 250. Each of the personal devices 270 and 280 may handshake with the electronic system 260 through an automatic or manual process. For example, an operator associated with one of the devices may instigate a connection via wireless networking (via network 250) to interact with the electronic system 260. The system 200 may store information of which devices are connected via the persistent store 205.

The personal preference receiver 220 receives a plurality of preference files from the interfaced devices. For example, as shown in FIG. 2, if personal device 270 and 280 are handshaking with the electronic system 260 (via a connection through network 250), the personal preferences 272 and 282 may be transmitted to the electronic system 260. The transmission of the various files may be accomplished on the client side (personal devices 270 and 280) through the TX/RX devices 271 and 281, respectively. The receiving of the personal preferences 272 and 282 may be accomplished via the communication adapter 261.

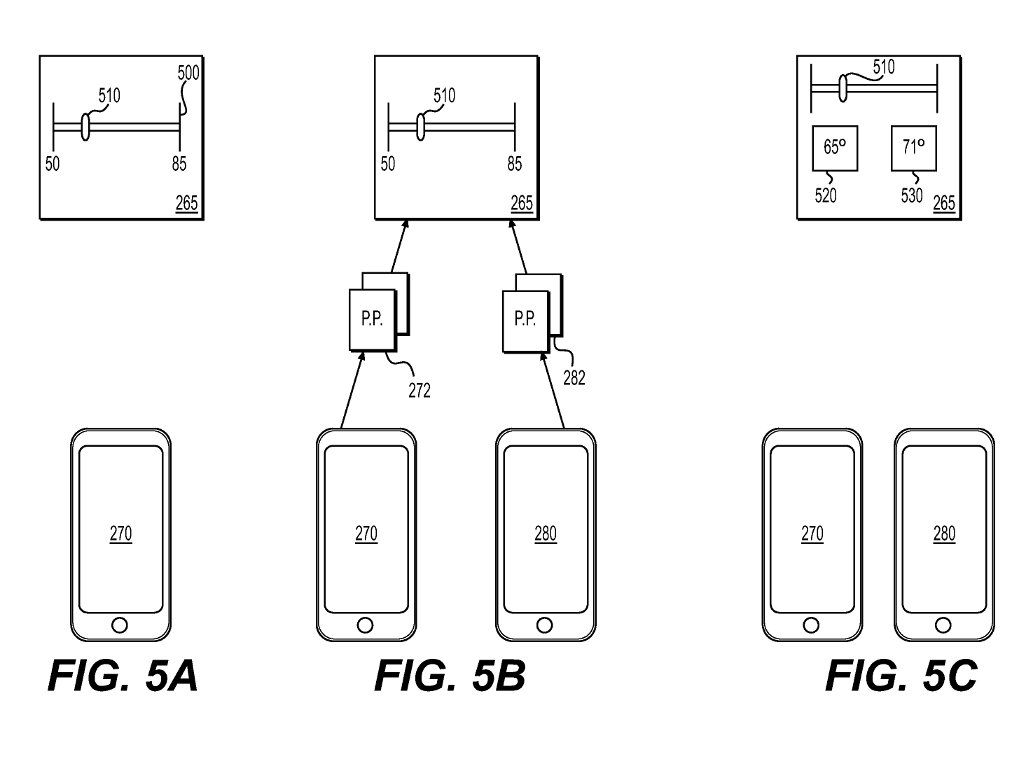

The personal preference extractor 230 may extract information from the personal preferences 272 and 282, including the source of the personal preferences 272 and 282 (i.e. the operators of personal devices 270 and 280), the preferences included in personal preferences 272 and 282. Examples of the preferences are shown in greater detail in FIGS. 5(a)-7(b) below.

An alternate implementation of FIG. 2 may include an opt-out or privacy setting. Thus, the operator associated with either device 270 or 280 may elect to selectively share some information and not all. In these situations, as explained in FIG. 3 with greater detail, the operator may indicate that none, some, or all of their personal preferences are to be shared. In the cases that the personal preferences are not shared, the system 200 blocks any sort of sharing associated with the personal preferences.

The personal preference sharer 240 collects the individual personal preferences (via personal preference files 272 and 282) and communicates the information 241 to the electronic system 260. The electronic system 260 may translate the collected information into viewable and/or engage-able information. The electronic system 260 may be coupled to various services, such as a climate control system 262, an infotainment system 263, and a navigation system 264. Examples of each service are provided below in greater detail.

The electronic system 260 is shown with a display device 265. The display device 265 may be any sort of digital display capable of representing information. Alternatively, the digital display 265 may be equipped with an interface device, such as those described above with regards to FIG. 1. For example, the digital display 265 may be incorporated with a touch screen capability, thereby allowing one of the operators of either personal device 270 or 280 to select a setting based on the shared personal preferences contained in the personal preference files 272 and 282.

FIG. 3 illustrates an example of a system 300 for facilitating the sharing of personal preference information 301 from a personal device (such as personal device 270 or 280) to the system 200. The system 300 may be stored in a persistent store, such as those shown above. The system 300 may be provided with a graphical user interface (not shown) to allow a user or operator to manually enter one's personal preferences. Alternatively, or in addition to, the system 300 may be provided with an automated learning technique or algorithm capable of learning the user or operator's preference.

The system 300 may include an initiator 310, a level setter 320, an app selector 330, and a personal preference selector 340. As shown in FIG. 2, the system 300 may communicate to the system 200 via a network 250.

The initiator 310 initiates a storing or updating of a personal preference file 301. The user or operator of a personal device (such as device 270 or 280) may request that an application or program capable of editing a personal preference is initiated. In another example, an application or program provided on a personal device 270 or 280 may interface with the electronic system 260 described above. The settings stored in the context or control of the electronic system 260 may be stored and saved as a personal preference file 301.

The level setter 320 may be optionally provided in an implementation of system 300. The level setter 320 allows a user or operator to set the level of access to other users or operators. For example, an operator may set that the personal preferences 301 may be shared with a predefined set of other users, no other users, or all other users. The level setter 320 may set a specific level for each set of personal preferences. Thus, the operator may set a level for climate control, and another for music or entertainment settings.

The app selector 330 allows an operator to select an application or setting associated with the personal preference file 301. For example, the operator may be allowed to set the climate control, audio preferences, and navigation settings. The app selector 330 allows the operator to select one of the above applications to set personal preferences for.

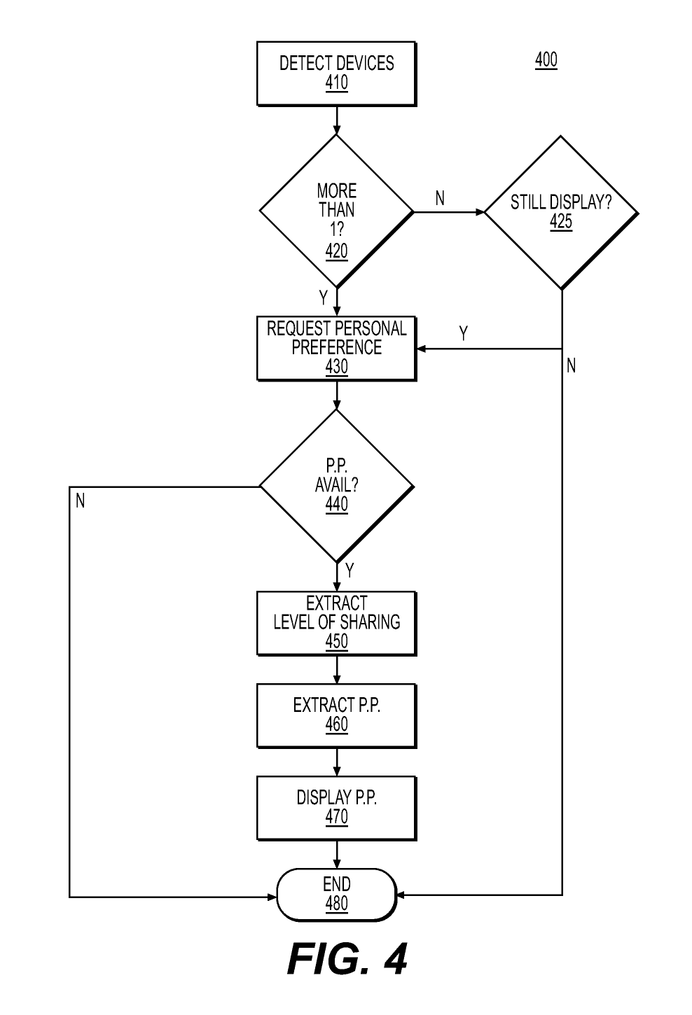

FIG. 4 illustrates an example of a method 400 for sharing preferences based on an interaction with an electronic system. The method 400 may be implemented on a system 200.

In operation 410, a detection of device(s) is made. For example, if multiple passengers of a vehicle enter, a server associated with the vehicle may wirelessly detect that multiple personal devices are within the proximity of the vehicle.

In operation 420, a determination is made as to whether there is more than one device present due to the detection in operation 410. If yes, the method 400 proceeds to operation 430. If no, a determination is made as to whether the display of personal preferences is to occur (operation 425). If the determination in operation 425 is yes, the method 400 proceeds to operation 430. If no, the method 400 proceeds to end (480). At the end 480, the method 400 may iteratively perform after a predetermined time period.

In operation 430, the personal preferences of the detected devices are requested. The request may occur via a network handshaking operation between the server requesting the information and each of the various personal devices.

In operation 440, a determination is made as to whether personal preference information is available (as received in operation 430). If no, the method 400 proceeds to operation 480 (the end 480). If yes, the method 400 proceeds to operation 450.

In operation 450, the level of sharing associated with each personal preference file retrieved may be extracted. This operation may be optionally provided. The level is defined similarly as explained in FIG. 3.

In operation 460, the personal preference of each file retrieved in operation 430 is extracted. The personal preference may then be displayed in operation 470. The GUI may display the personal preference of each file next to the device that the personal preference retrieved is associated with.

The following explanations and figures illustrate examples of implementations of the systems and methods described above. In the examples shown, two devices interact with an electronic system 260 (not shown). The electronic system 260 has a display 265 (shown). While two devices are shown, the number devices present is merely exemplary.

FIGS. 5(a)-(c) illustrate an implementation of system 200 and 300 for providing control of a climate control system 500. As shown in FIG. 5(a), the climate control system 500 is displayed via display 265. The climate control system 500 is displayed with a GUI element 510 to select and set the temperature (from a range of 50 to 85 degrees).

In FIG. 5(b), a second device 280 joins the proximity of the first device 270. Accordingly, the first and second device 270 and 280 may transmit a personal preference file (272 and 282 respectively). The first and second devices 270 and 280 each may have a system 300 implemented therein, thus, allowing the owner or operator of the devices to set their personal preferences in accordance with climate settings.

As shown in FIG. 5(c), the personal preferences of each device are shown. Thus, an operator of the electronic system 260 may be cognizant of the desires associated with each user or operator. The owner of the first device 270 may desire to have a temperature of 65 degrees (520) while the owner of the second device 280 may desire to have a temperature of 71 degrees.

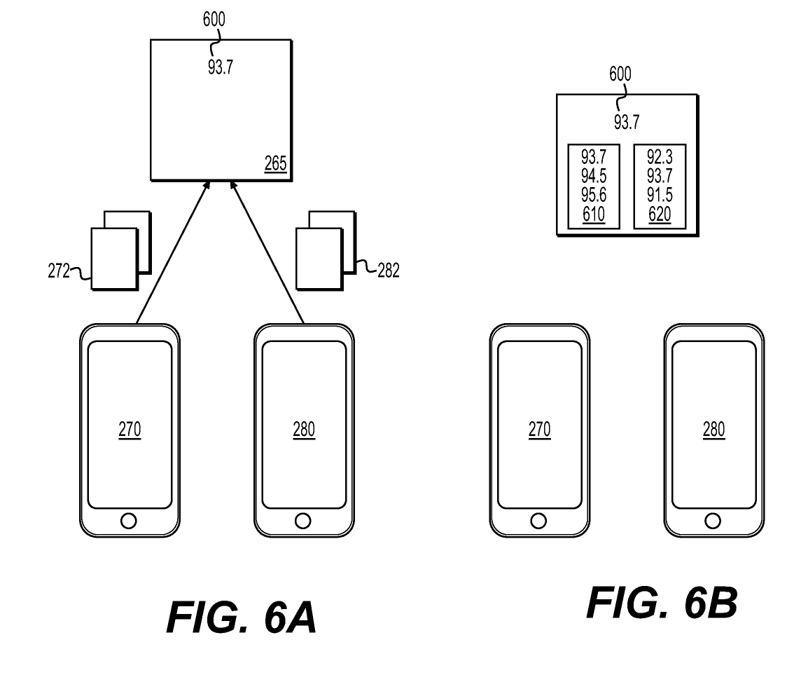

FIGS. 6(a) and (b) illustrate an example of an implementation of the system 200 and 300 for controlling a radio station. The scenario is similar to the example shown above with regards to FIGS. 5(a)-(c), with a notable difference that the display 265 is now configured to display an entertainment GUI 600.

Referring to FIG. 6(a), similar to the operation shown in FIG. 5(b), personal preferences are transmitted to the electronic system 260. The electronic system 260 processes the personal preference files 272 and 282 in the manner described in FIG. 2 (via system 200), and produces the output shown in FIG. 6(b).

In FIG. 6(b), the preferences associated with device 270 and 280 are shown on display 265 via GUI 600. The GUI 600 shows preference 610 (device 270) and preference 620 (device 280). Each of the preferences 610 and 620 indicate a list of radio stations preferred by the owner and operator of device 270 and 280.

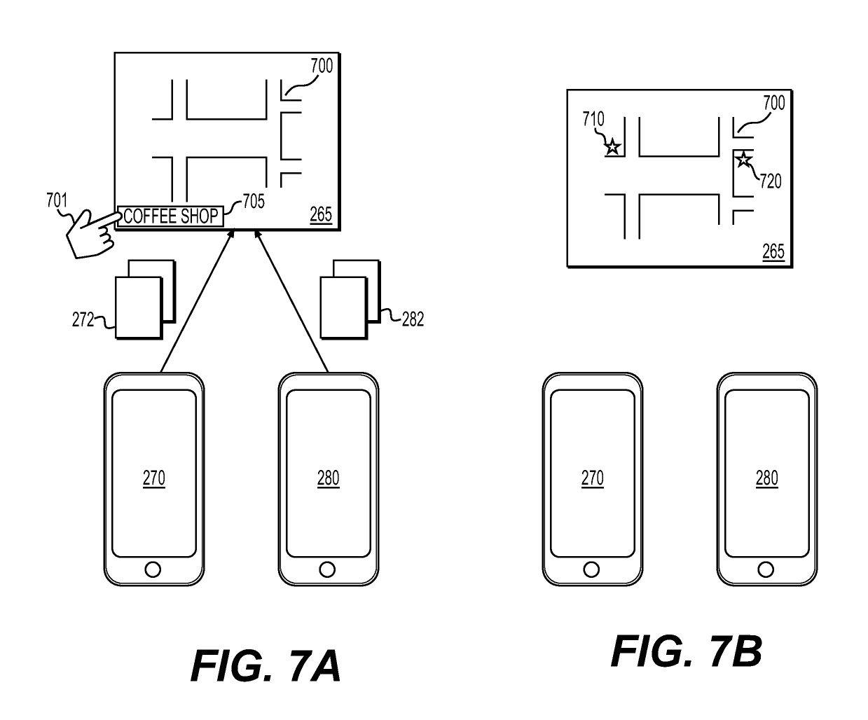

FIGS. 7(a) and (b) illustrate example implementations of the system 200 and 300 for controlling a navigation system 700. As shown in FIGS. 7(a) and (b), the navigation system 700 shows a map of a portion of an area. The navigation system 700 is displayed on a display 265.

In FIG. 7(a), a user 701 engages a GUI element 705 to display a category (in the example shown, the category is ‘coffee shops’). As shown in FIG. 7(a), the personal preferences 272 and 282 are transmitted from the devices 270 and 280.

In FIG. 7(b), the navigation system 700 shows coffee shop 710 and 720. Coffee shop 710 refers to a personal preference associated with device 270, while coffee shop 720 refers to a personal preference associated with device 280. Thus, viewing the display 265, an operator of the electronic system 260 may be cognizant of each person's personal preference.

The examples shown the various FIGS. 5(a)-7(b) may be selectively combined and provided together, with each employing various aspects of the concepts disclosed above.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

We claim:

1. A system for sharing visual representations of personal preferences based on an interaction between a first and second personal devices and an electronic system, comprising:
a data store comprising a computer readable medium storing a program of instructions for the displaying of the personal preferences;
a processor that executes the program of instructions;
a device interfacer to interface with at least the first personal device and the second personal device in response to the first personal device and the second personal device being within a proximal distance from each other and the electronic system;
a personal preference receiver configured to receive a first personal preference file from the first personal device, and a second personal preference file from the second personal device;
a personal preference extractor to extract personal preferences from each of the received personal preference files; and
a personal preference sharer configured to communicate the extracted personal preferences to a display associated with the electronic system.

2. The system according to claim 1, wherein the first and the second personal devices are mobile computing devices.

3. The system according to claim 2, wherein the electronic system is a vehicular infotainment system.

4. The system according to claim 3, wherein the electronic system is a climate control system, the received personal preferences correspond to a predefined preference associated with a climate setting.

5. The system according to claim 3, wherein the electronic system is an infotainment system, the received personal preferences correspond to a predefined preference associated with entertainment options.

6. The system according to claim 3, wherein the electronic system is a navigation system, the received personal preferences correspond to a predefined set of locations.

7. The system according to claim 1, wherein the shared personal preferences is engage-able as a graphical user interface (GUI).

8. The system according to claim 1, wherein the device interfacer detects the connection between the first and second personal devices via a network connection provided via the electronic system and independent a wide-area network.

9. The system according to claim 1, wherein the personal preferences is at least one of an individual preference, a range of preferences, or a distribution of preferences.

10. A system for setting personal preferences for displaying via an electronic system in communicated with a personal device, comprising:
a data store comprising a computer readable medium storing a program of instructions for the setting;
a processor that executes the program of instructions;
an intiator to initiate an updating of the personal preference;
a level setter to associate with the personal preference a permission of other personal devices that may view the personal preference;
an application selector to select which of available applications to modify the personal preferences,
wherein the personal preference is configured to be displayed via a centrally provided electronic system, the electronic system configured to provide a localized network in which the personal device and other personal devices connect to.

11. The system of claim 10, wherein the available applications consist of climate systems, entertainment systems, and navigation systems.

12. A method for displaying personal preferences based on an interaction of a first and second personal devices and an electronic system, comprising:
detecting whether either the first device and the second device are in a proximal distance from the electronic system;
requesting personal preferences from the detected first device and the detected second device;
receiving personal preferences from the detected first device and the detected second device;
extracting personal preferences from each of the detected first device and the detected second device;
categorizing the received personal preferences as being associated with either the detected first device and the detected second device; and
displaying the received and categorized personal preferences.

13. The method according to claim 12, wherein the first and the second personal devices are mobile computing devices.

14. The method according to claim 13, wherein the electronic system is a vehicular infotainment system.

15. The method according to claim 14, wherein the electronic system is a climate control system, the received personal preferences correspond to a predefined preference associated with a climate setting.

16. The method according to claim 14, wherein the electronic system is an infotainment system, the received personal preferences correspond to a predefined preference associated with entertainment options.

17. The method according to claim 14, wherein the electronic system is a navigation system, the received personal preferences correspond to a predefined set of locations.

18. The method according to claim 12, wherein the displayed personal preferences is engage-able as a graphical user interface (GUI).

19. The method according to claim 12, wherein the detection only occurs between the first and second personal devices via a network connection provided via the electronic system and independent a wide-area network.

20. The method according to claim 12, further comprising extracting a level information associated with each received personal preference, the level information containing restrictions on a predefined subset of devices to share information with.
